(19) United States
(12) Patent Application Publication
(10) Pub. No.: US 2025/0017386 A1
(43) Pub. Date: Jan. 16, 2025

(54) SADDLE SLEEPER

(71) Applicant: Dragovich Creations, LLC, Arvada, CO (US)

(72) Inventor: Brad Drake, Golden, CO (US)

(21) Appl. No.: 18/903,282

(22) Filed: Oct. 1, 2024

Related U.S. Application Data
(63) Continuation of application No. PCT/US23/15630, filed on Mar. 20, 2023.
(60) Provisional application No. 63/326,732, filed on Apr. 1, 2022.

(51) Int. Cl. A47C 20/04

(52) U.S. Cl. CPC A47C 20/04

(57) ABSTRACT

The saddle sleeper allows a person (e.g., adults or children) to sleep in an angled position on their stomach (e.g., upper torso) and head in a straddle, sitting-like position, which helps reduce a variety of symptoms that are tied to specific medical conditions. In one example, the angled position may help a person to reduce and/or eliminate congestion and/or coughing while attempting to sleep when it's due to a common cold, flu or disease.

### CROSS-REFERENCE TO RELATED APPLICATIONS

This application is a continuation application of PCT International Application No. PCT/US2023/015630 filed on Mar. 20, 2023, entitled “Saddle Sleeper,” which claims the benefit of U.S. Provisional Application No. 63/326,732 entitled “Incline Sleeper” filed Apr. 1, 2022, the disclosures of which are incorporated by reference herein in their entireties.

### TECHNICAL FIELD

The disclosure relates to a bed, sleeper or cradle that includes angles of inclination to allow a person to be supported comfortably during use. More specifically, the disclosure relates to a sleeper or bed that includes angles of inclination to allow a person to sleep in straddled, forward facing position to reduce symptoms due to a variety of medical conditions.

### BACKGROUND OF THE INVENTION

It can be difficult for children with the flu, asthma, upper respiratory infections, and allergies to fall asleep and stay asleep at night due to constant coughing, hacking, and wheezing. This can result in excess drainage and mucus, which can contaminate pillows, blankets and sheets, as well as create sore throats that make it difficult to eat or swallow during the waking hours. Unfortunately, parents can also lose sleep from the constant noise and the overall concern for their children's health.

Currently, there are various inclined beds on the market, but these apparatuses require children to lie on their back or side, allowing congestion to build, and can subject children to falling from or sliding off of the incline to the bottom, possibly becoming pinned during the night. The current inclined beds contain sleeping surfaces that require a user to sleep on his or her back and do not enable a user to sleep in a face down position in a manner recommended for optimal drainage.

### BRIEF DESCRIPTION OF FIGURES

FIGS. 1A-1C display multiple views of a first embodiment of a saddle sleeper without padding;

FIGS. 2A-2B display multiple views of a young child sleeping the saddle sleeper of FIGS. 1A-1C with pads;

FIGS. 3A-3D display multiple views a second embodiment of a saddle sleeper;

FIGS. 4A-4H display multiple views and a cross-section view of a third embodiment of a saddle sleeper;

FIGS. 5A-5C display multiple views of a fourth embodiment of a folded saddle sleeper;

FIGS. 5D-5F display multiple views of the saddle sleeper of FIGS. 5A-5C unfolded;

and

FIGS. 6A-6B display different embodiments of different regions and planes of a human anatomy.

### BRIEF SUMMARY OF INVENTION

In one embodiment, the sleeper comprising: a first surface, the first surface comprises a first top width, a first bottom width, a first surface shape and a first surface angle, the first bottom width is smaller than the first top width, the first surface is configured to support at least a portion of a ventral side of an upper torso of a person; a second surface, the second surface comprises a second top width, a second bottom width, a second surface shape and a second surface angle, the second bottom width is smaller than the second top width, the second surface is configured to support at least a portion of a dorsal side of a buttocks of a person; the first surface and the second surface intersect at an intersection region at a surface orientation angle, the intersection region includes an intersection height and an intersection width; and a base, the base supporting the first surface and the second surface.

In another embodiment, the sleeper comprising: a first surface, the first surface comprises a first surface width, a first surface shape and a first surface angle, the first surface is configured to support at least a portion of a ventral side of an upper torso of a person; a second surface, the second surface comprises a second surface width, a second surface shape and a second surface angle, the second surface is configured to support least a portion of a buttocks of a person; the first surface and the second surface intersect at a surface orientation angle at an intersection region, the intersection region includes an intersection width, intersection height, the intersection width comprises a smaller width than the first surface width and a second surface width; and a base, the base supporting the first surface and the second surface.

In another embodiment, the adjustable sleeper comprising: a first surface, a second surface, a base and a locking mechanism; the first surface comprises a first surface width, a first surface shape and a first surface angle, the first surface is configured to support at least a portion of a ventral side of an upper torso of a person; the second surface comprises a second surface width, a second surface shape and a second surface angle, the second surface is configured to support least a portion of a buttocks of a person; the first surface and the second surface intersect at one or more surface orientation angles at an intersection region, the intersection region includes an intersection width, intersection height, the intersection width comprises a smaller width than the first surface width and a second surface width; the base comprising a first portion, a second portion and one or more base orientation angles, the first portion of the base supporting the first surface and the second portion of the base supporting the second surface, the first portion of the base moves relative to the second portion of the base while changing the base orientation angle and the surface orientation angle of the first surface and second surface; the locking mechanism engaging with the base, first surface and/or second surface to secure or set the desired one or more base orientation angle or the one or more surface orientation angle. The adjustable sleeper is movable from a first position, an unlocked, folded configuration, to a second position, a locked, unfolded or open configuration.

### DETAILED DESCRIPTION OF INVENTION

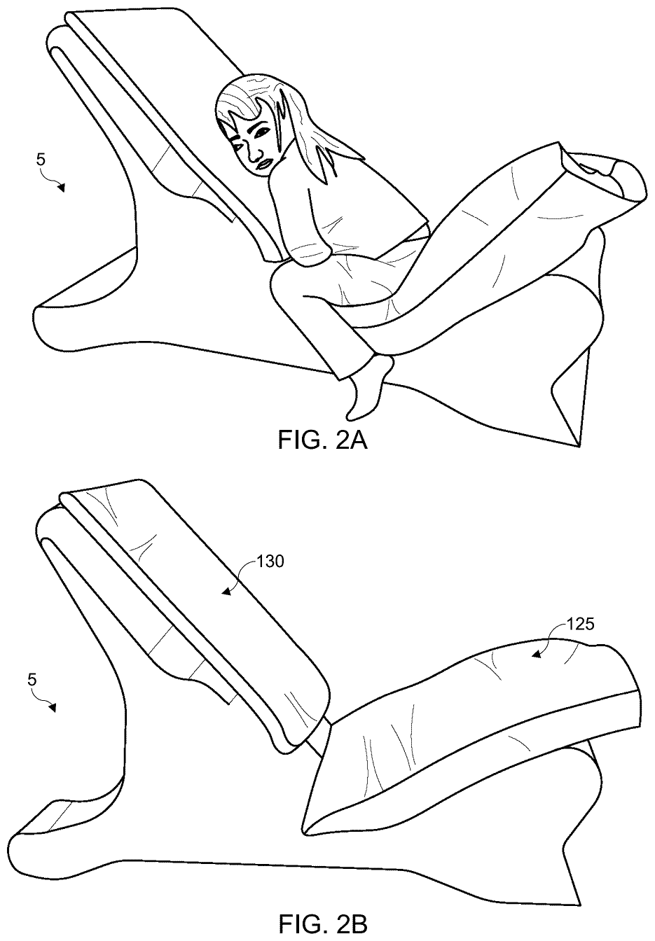

There exists a need for an improved saddle or straddle sleeper 5, 135, 155, 165 that enables a person to eliminate or reduce one or more symptoms while they are sleeping. The saddle or straddle sleeper 5, 135, 155, 165 is designed to enable a person to sleep on their stomachs or upper torso in an angled orientation while still enabling them to touch the ground to aid in stability (see FIGS. 2A-2B). The angled orientation of the sleeper 5, 135, 155, 165 allows a person to take advantage of gravity to simulate or substantially simulate the natural drainage and blood flow of the body while a person is sitting upright. The angled orientation also helps reduce or eliminate coughing and/or congestion while trying to sleep.

Accordingly, the sleeper 5, 135, 155, 165 can also be used for a variety of other medical applications or medical conditions that require the improvement of symptoms while at an angled orientation, including persons who may have cystic fibrosis, acid reflux, night-time cough, sleep apnea, sinus congestion, other pulmonary conditions, ear infections, glaucoma, ocular hypertension, cold, flu, allergies and/or any combination thereof. The first and second surface angles or angled orientations may match or substantially match the angle needed for proper postural drainage therapy (15 to 45 degrees) and/or the reduction or elimination of symptoms of any relevant medical conditions. The sleeper 5, 135, 155, 165 further comprises different sizes. The sizes may include general sizing such as small, medium, large or x-large. Also, the size may include custom sized sleepers 5, 135, 155, 165 for any person, the persons include adults and children.

The sleeper 5, 135, 155, 165 comprises a forward-facing surface that can be sized and configured for different persons, including adults, children and/or toddlers. The sleeper 5, 135, 155, 165 can sit on a floor for easy access and safety. It may also be positioned next to a bed if desired to add further stability and support. The sleeper 5, 135, 155, 165 can include an angled forward-leaning seat that supports the buttocks with another angled platform surface for supporting the upper torso (e.g., chest and abdomen) and head to rest thereto.

In one embodiment, the sleeper 5, 135, 155, 165 comprises a first surface 15a, 15b, 15c, 15d, a second surface 50a, 50b, 50c, 50d and a base 10a, 10b, 10c, 10d; the base 10a, 10b, 10c, 10d supports the first surface 15a, 15b, 15c, 15d and the second surface 50a, 50b, 50c, 50d. The first surface 15a, 15b, 15c, 15d, the first surface 15a, 15b, 15c, 15d comprises a first top width 40a, 40b, 40c, 40d, a first bottom width 45a, 45b, 45c, 45d, a first surface shape and a first angle 95a, 95b, 95c, 95d, the first bottom width 45a, 45b, 45c, 45d is smaller than the first top width 40a, 40b, 40c, 40d, the first surface 15a, 15b, 15c, 15d is configured to contact or support at least a portion of a frontal plane or anterior facing anatomical regions of an upper torso of a person; the second surface 50a, 50b, 50c, 50d comprises a second top width 55a, 55b, 55c, 55d, a second bottom width 60a, 60b, 60c, 60d, a second surface shape and a second angle 90a, 90b, 90c, 90d, the second bottom width 60a, 60b, 60c, 60d is smaller than the second top width 55a, 55b, 55c, 55d, the second surface 50a, 50b, 50c, 50d is configured to contact or support at least a portion of a buttocks of a person or configured to support at least a portion of posterior facing anatomical regions of a person's lower torso; the first surface 15a, 15b, 15c, 15d and the second surface 50a, 50b, 50c, 50d intersect at an orientation angle 220a, 220b, 220c, 220d at an intersection region 20a, 20b, 20c, 20d, the intersection region 20a, 20b, 20c, 20d includes an intersection height 215a, 215b, 215c, 215d and an intersection shape.

In another embodiment, the sleeper comprises: the sleeper 5, 135, 155, 165 comprises a first surface 15a, 15b, 15c, 15d, a second surface 50a, 50b, 50c, 50d and a base 10a, 10b, 10c, 10d. The first surface 15a, 15b, 15c, 15d comprises a first surface width 40a, 40b, 40c, 40d, a first surface shape and a first surface angle 95a, 95b, 95c, 95d, the first surface 15a, 15b, 15c, 15d is configured to contact at least a portion of a frontal plane or anterior facing anatomical regions of an upper torso of a person; the second surface 50a, 50b, 50c, 50d comprises a second surface width 45a, 45b, 45c, 45d, a second surface shape and a second surface angle, the second surface 50a, 50b, 50c, 50d is configured to contact at least a portion of a buttocks of a person or configured to support at least a portion of posterior facing anatomical regions of a person's lower torso; the first surface 15a, 15b, 15c, 15d and the second surface 50a, 50b, 50c, 50d intersect at a non-parallel angle 220a, 220b, 220c, 220d at an intersection region, the intersection region 20a, 20b, 20c, 20d includes an intersection width, intersection height 215a, 215b, 215c, 215d, and an intersection shape, the intersection width comprises a smaller width than the first surface width 40a, 40b, 40c, 40d and a second surface width 45a, 45b, 45c, 45d; and the base 10a, 10b, 10c, 10d is supporting the first surface 15a, 15b, 15c, 15d and the second surface 50a, 50b, 50c, 50d.

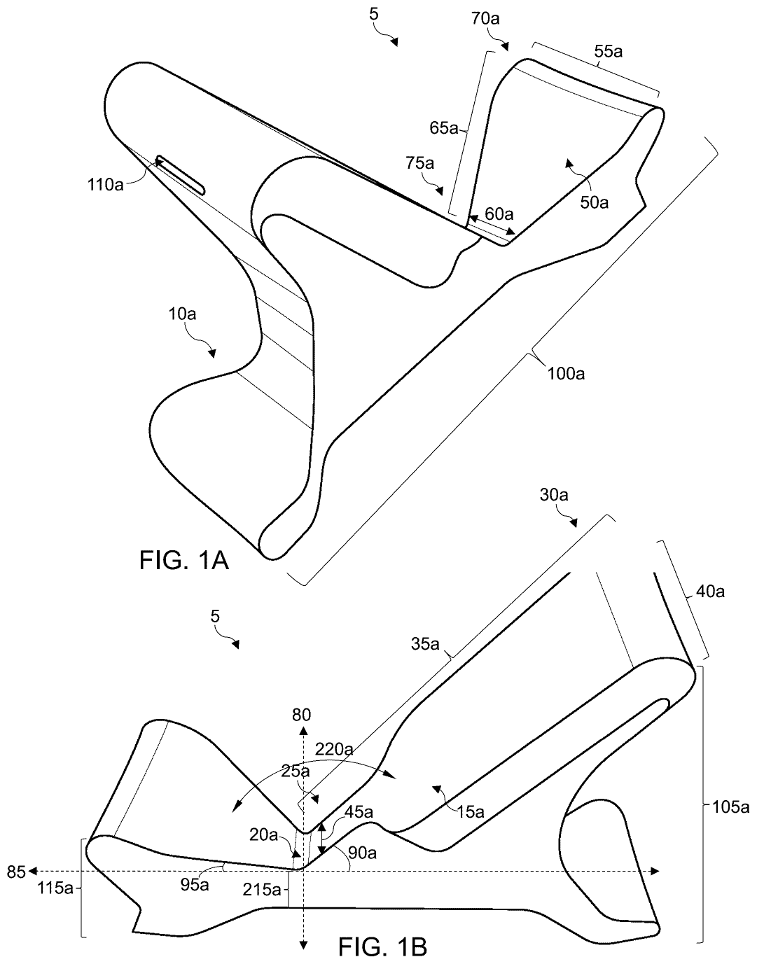

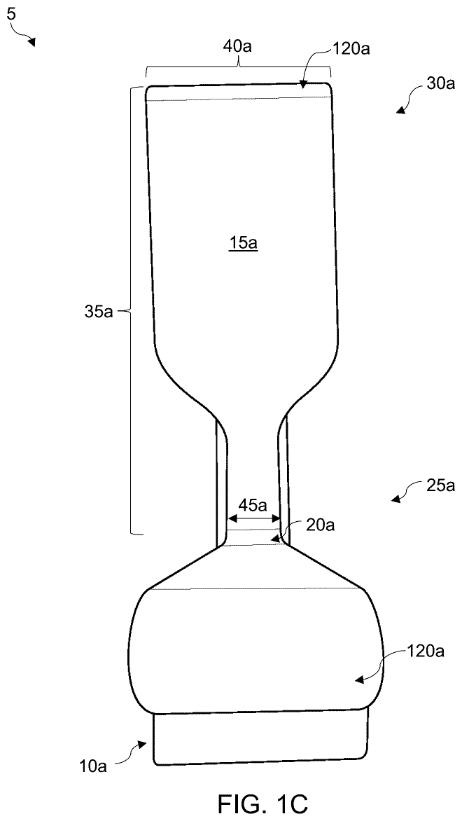

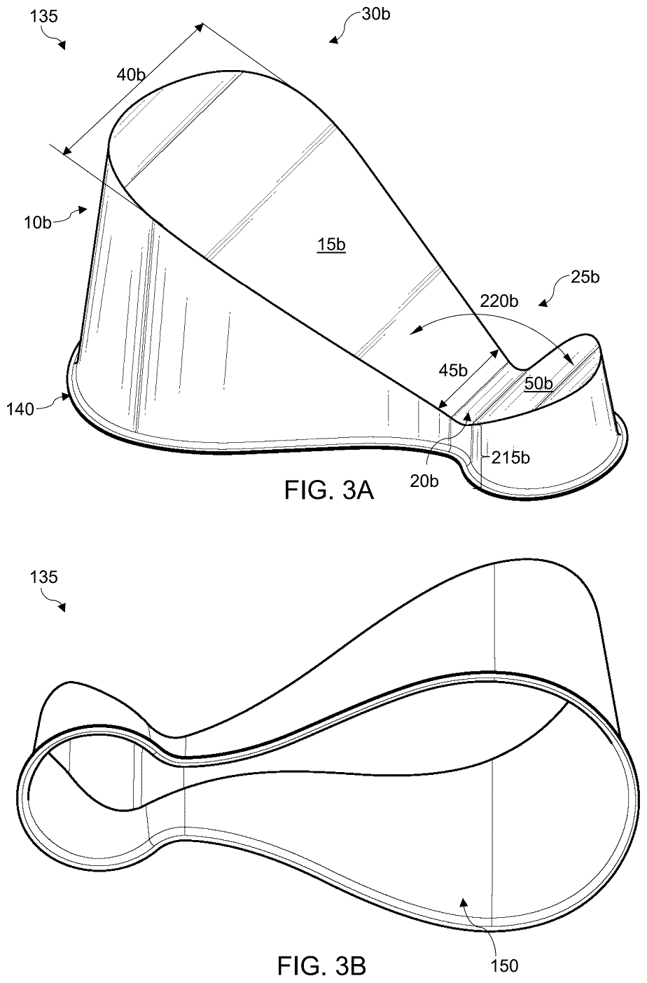

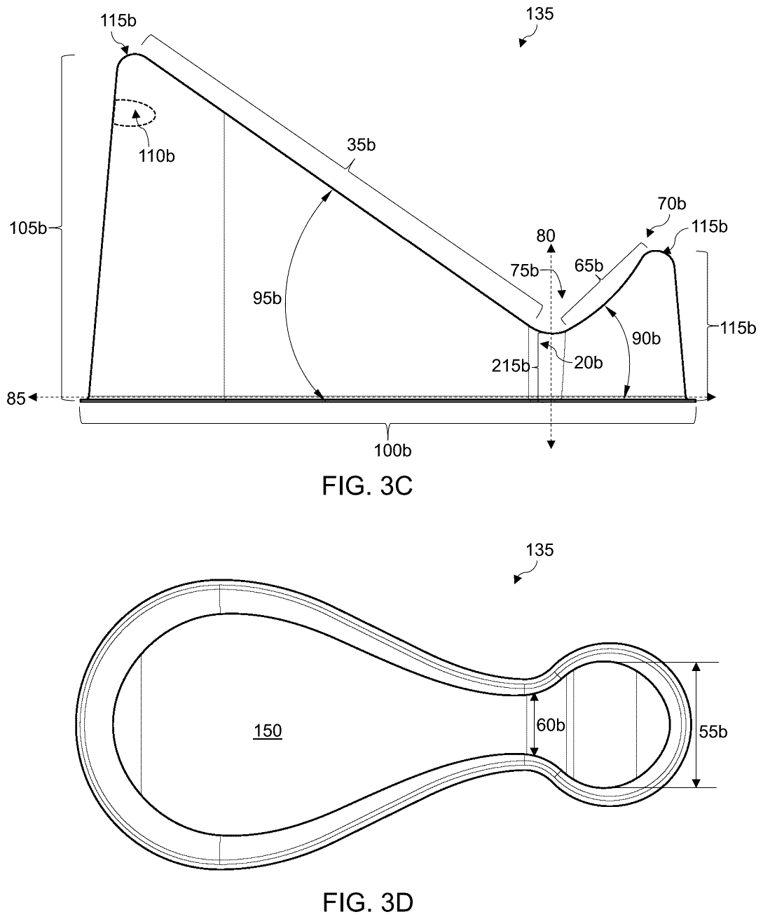

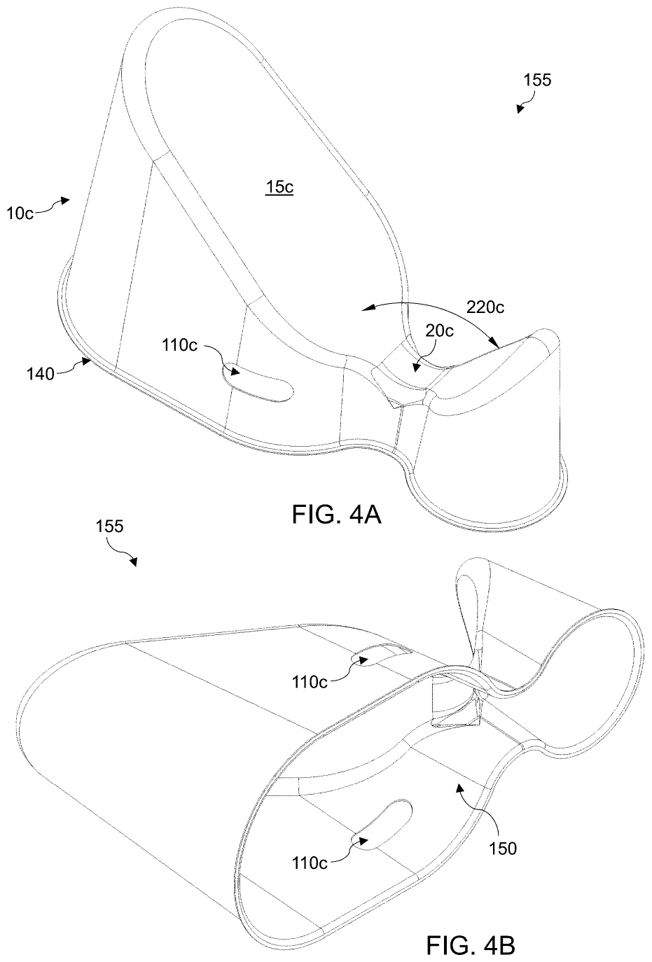

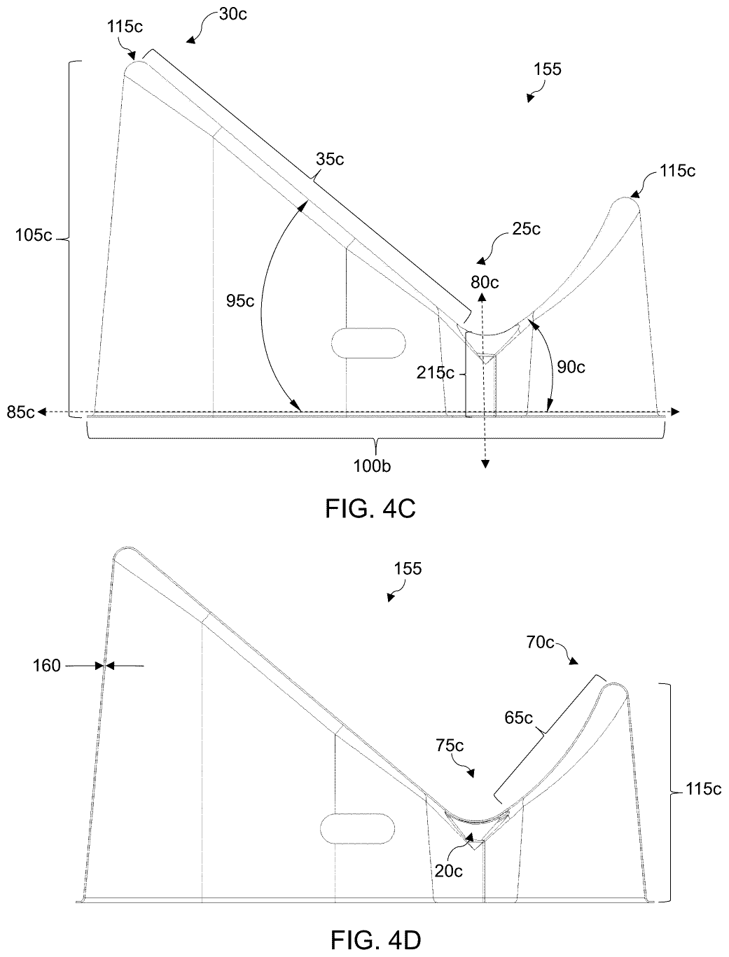

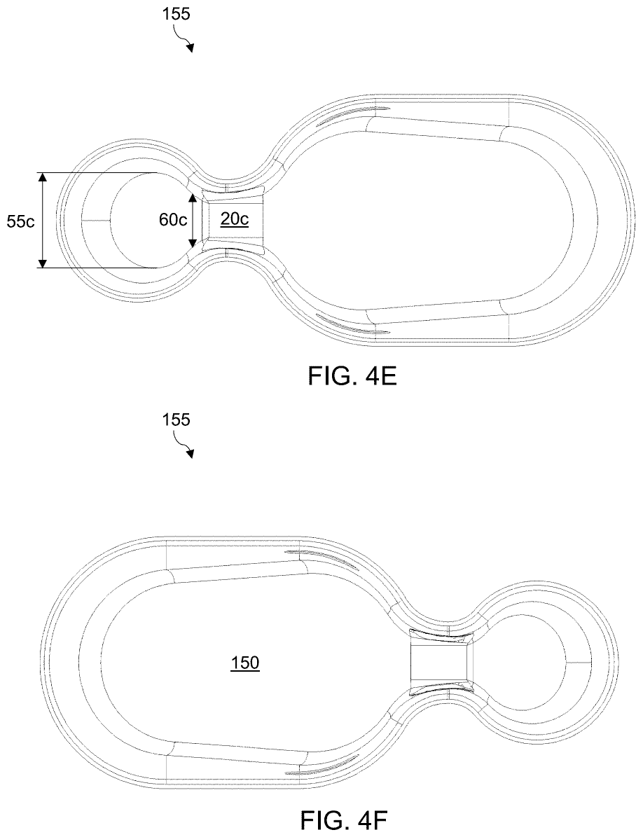

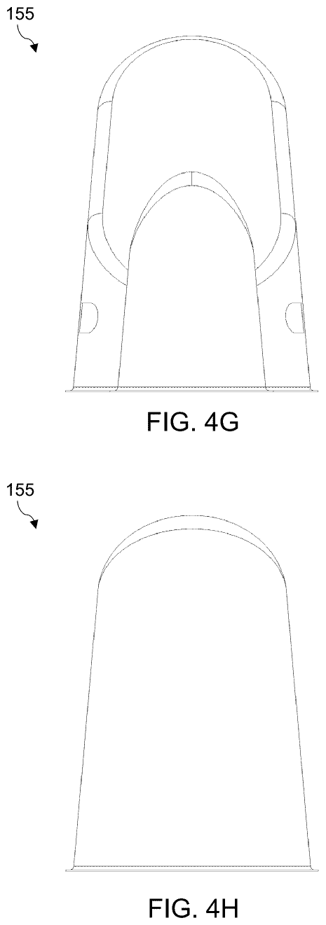

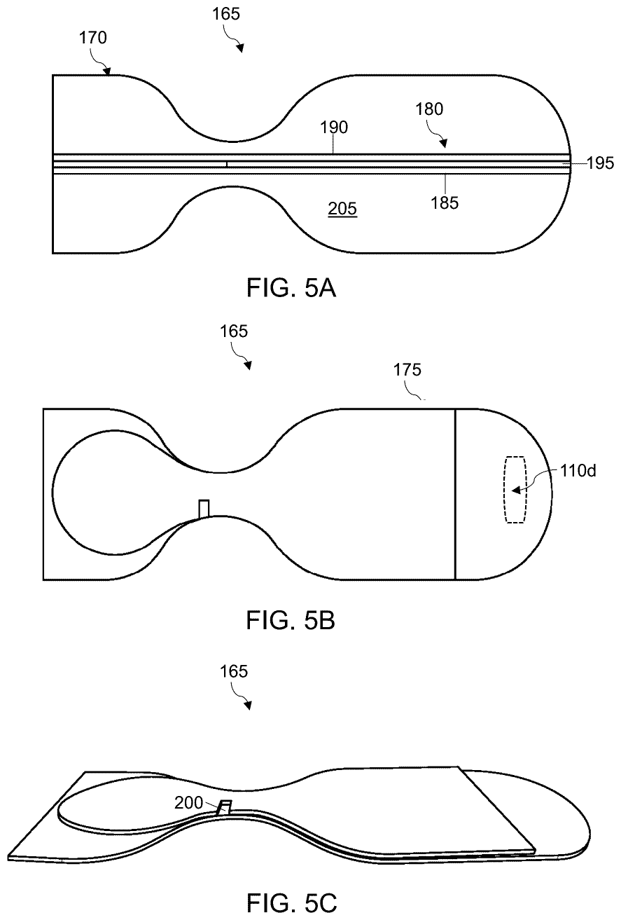

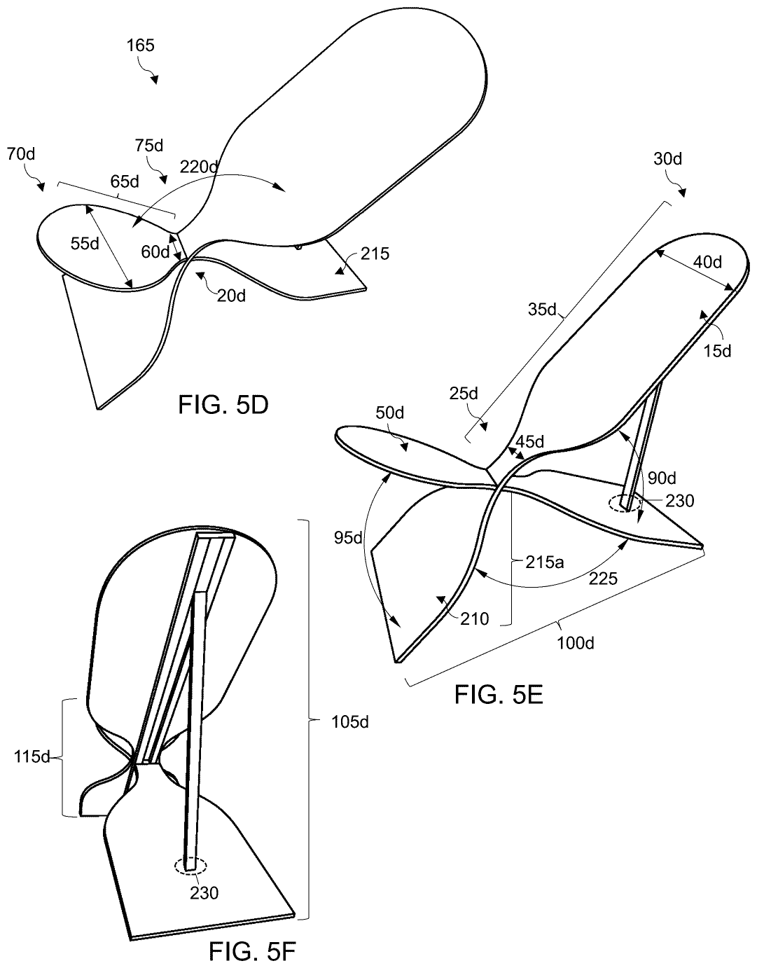

Referring to FIGS. 1A-1C, 2A-2B, 3A-3D, 4A-4H, and 5D-5F, the sleeper 5, 135, 155, 165 comprises a first surface 15a, 15b, 15c, 15d, a second surface 50a, 50b, 50c, 50d and a base 10a, 10b, 10c, 10d. The base 10a, 10b, 10c, 10d supports the first surface 15a, 15b, 15c, 15d and the second surface 50a, 50b, 50c, 50d. The first surface 15a, 15b, 15c, 15d comprises a first top end 30a, 30b, 30c, 30d, a first bottom end 25a, 25b, 25c, 25d, a first surface shape, a first top width 40a, 40a, 40c, 40d, a first bottom width 45a, 45b, 45c, 45d, a first surface height 105a, 105b, 105c, 105d, a first surface length 35a, 35b, 35c, 35c and/or a first surface angle 95a, 95b, 95c, 95d.

The first top width 40a, 40b, 40c, 40d is at or adjacent to the first top end 30a, 30b, 30c, 30d. The first top width 40a, 40b, 40c, 40d comprises a width of at least 15 inches or greater; comprises a width of 17 inches or greater; comprises a width of 15 inches to 20 inches; and/or comprises a width of 16 to 18 inches. The first bottom width 45a, 45b, 45c, 45d is at or adjacent to the first bottom end 25a, 25b, 25c, 25d. The first bottom width 45a, 45b, 45c, 45d comprises a width of at least 5 inches or greater; comprises a width of at least 6 inches or greater; comprises a width of 4 to 10 inches; comprises a width of 5 to 8 inches; and/or comprises a width of 6 to 8 inches. Accordingly, the first top width 40a, 40b, 40c, 40d is greater than the first bottom width 45a, 45b, 45c, 45d. The first bottom width 45a, 45b, 45c, 45d comprises a smaller width than the first top width 40a, 40b, 40c, 40d.

The first surface 15a, 15b, 15c, 15d comprises a first surface angle 95a, 95b, 95c, 95d. The first surface angle 95a, 95b, 95c, 95d is positioned relative to the floor and/or the longitudinal axis 85. The first surface angle 95a, 95b, 95c, 95d comprises an angle of at least 20 degrees or greater; comprises an angle of at least 25 degrees or greater; comprises an angle of 30 degrees or greater; comprises an angle of 35 degrees or greater; comprises an angle of 40 degrees or greater; comprises an angle of 20 degrees to 50 degrees; comprises an angle of 30 degrees to 50 degrees; and/or comprises an angle of 35 degrees to 45 degrees.

The first surface 15a, 15b, 15c, 15d comprises a first surface height 105a, 105b, 105c, 105d. The first surface height 105a, 105b, 105c, 105d comprises a height of at least 15 inches or greater; the first surface height 105a, 105b, 105c, 105d comprises of at least 20 inches or greater; the height comprises at least 23 inches or greater; the height comprises 15 inches to 25 inches; the height comprises at least 20 inches to 25 inches; and/or the height comprises 22 inches to 24 inches. The first surface height 105a, 105b, 105c, 105d may be at or adjacent to the first top end 30a, 30b, 30c, 30d of the first surface 15a, 15b, 15c, 15d.

The first surface 15a, 15b, 15c, 15d comprises a first surface length 35a, 35b, 35c, 35d. The first surface length 35a, 35b, 35c, 35d comprises a length of at least 15 inches or greater; comprises a length of at least 20 inches or greater; comprises a length of at least 25 inches or greater; comprises a length of at least 28 inches or greater; comprises a length of 20 inches to 30 inches; comprises a length of 25 inches to 30 inches; and/or comprises a length of 27 inches to 29 inches.

The first surface 15a, 15b, 15c, 15d comprises a first surface shape. The first surface shape may include a profile shape, the profile shape comprises a flat, curved or concave surface. The curved or concave shaped surface may be sized and configured to accommodate a person's torso, e.g., an adult or a child. The first surface shape may further include an oval, circular, and/or any polygonal shape. The polygonal shape includes a triangle, a square, a rectangle, a heptagon, a hexagon, and/or any combination thereof. The first surface shapes may further include rounded polygonal shapes, such as a rounded-triangle, a rounded-square, a rounded rectangular, a rounded-heptagon, a rounded-hexagon, and/or any combination thereof.

Also, referring to FIGS. 1A-1C, 2A-2B, 3A-3D, 4A-4H, and 5D-5F, the sleeper 5, 135, 155, 165 comprises a second surface 50a, 50b, 50c, 50d. The second surface 50a, 50b, 50c, 50d comprises a second top end 70a, 70b, 70c, 70d, a second bottom end 75a, 75b, 75c, 75d, a second surface shape, a second top width 55a, 55b, 55c, 55d, a second bottom width 60a, 60b, 60c, 60d, a second surface height 115a, 115b, 115c, 115d, and/or a second surface angle 90a, 90b, 90c, 90d.

The second top width 55a, 55b, 55c, 55d is at or adjacent to the second top end 70a, 70b, 70c, 70d. The second top width 55a, 55b, 55c, 55d comprises a width of at least 5 inches or greater; comprises a width of 10 inches or greater; comprises a width of 5 inches to 15 inches; and/or comprises a width of 8 to 11 inches. The second bottom width 60a, 60b, 60c, 60d is at or adjacent to the second bottom end 75a, 75b, 75c, 75d. The second bottom width 60a, 60b, 60c, 60d comprises a width of at least 2 inches or greater; comprises a width of at least 4 inches or greater; comprises a width of 2 to 6 inches; comprises a width of 3 to 6 inches; and/or comprises a width of 4 to 5 inches. Accordingly, the second top width 55a, 55b, 55c, 55d is greater than the second bottom width 60a, 60b, 60c, 60d. The second bottom width 60a, 60b, 60c, 60d comprises a smaller width than the second top width 55a, 55b, 55c, 55d.

The second surface 50a, 50b, 50c, 50d comprises a second surface angle 90a, 90b, 90c, 90d. The second surface angle 90a, 90b, 90c, 90d is positioned relative to the floor and/or the longitudinal axis 85. The second surface angle 90a, 90b, 90c, 90d comprises an angle of at least 20 degrees or greater; comprises an angle of at least 25 degrees or greater; comprises an angle of 30 degrees or greater; comprises an angle of 35 degrees or greater; comprises an angle of 40 degrees or greater; comprises an angle of 20 degrees to 50 degrees; comprises an angle of 30 degrees to 50 degrees; and/or comprises an angle of 35 degrees to 45 degrees.

The second surface 50a, 50b, 50c, 50d comprises a second surface height 115a, 115b, 115c, 115d. The second surface height 115a, 115b, 115c, 115d comprises a height of at least 15 inches or greater; the first surface height 105a, 105b, 105c, 105d comprises of at least 10 inches or greater; the height comprises at least 13 inches or greater; the height comprises a 10 inches to 15 inches; the height comprises at least 10 inches to 14 inches; and/or the height comprises 12 inches to 14 inches. The second surface height 115a, 115b, 115c, 115d may be at or adjacent to the second top end 70a, 70b, 70c, 70d of the second surface 50a, 50b, 50c, 50d.

The second surface 50a, 50b, 50c, 50d comprises a second surface length 65a, 65b, 65c, 65d. The second surface length 65a, 65b, 65c, 65d comprises a length of at least 5 inches or greater; comprises a length of at least 7 inches or greater; comprises a length of at least 10 inches or greater; comprises a length of 5 inches to 15 inches; comprises a length of 7 inches to 13 inches; and/or comprises a length of 10 inches to 12 inches.

The second surface 50a, 50b, 50c, 50d comprises a second surface shape. The second surface shape may include a flat, curved or concave surface. The curved or concave shaped surface may be sized and configured to accommodate a person's torso, e.g., an adult or a child. The first surface shape may further include oval, circular, and/or any polygonal shape. The polygonal shape includes a triangle, a square, a rectangle, a heptagon, a hexagon, and/or any combination thereof. The second surface shapes may further include rounded polygonal shapes, such as a rounded-triangle, a rounded-square, a rounded rectangular, a rounded-heptagon, a rounded-hexagon, and/or any combination thereof.

In one embodiment, the first surface angle 95a, 95b, 95c, 95d may comprise a same angle than the second surface angle 90a, 90b, 90c, 90d. The first surface angle 95a, 95b, 95c, 95d may comprise a different angle than the second surface angle 90a, 90b, 90c, 90d. The first surface height 105a, 105b, 105c, 105d may comprise a same height than the second surface height 115a, 115b, 115c, 115d. The first surface height 105a, 105b, 105c, 105d may comprise a different height than the second surface height 115a, 115b, 115c, 115d. The first top width 40a, 40b, 40c, 40d may comprise a same width than the second top width 55a, 55b, 55c, 55d. The first top width 40a, 40b, 40c, 40d may comprise a different width than the second top width 55a, 55b, 55c, 55d. The first bottom width 45a, 45b, 45c, 45d may comprise a same width as the second bottom width 60a, 60b, 60c, 60d. The first bottom width 45a, 45b, 45c, 45d may comprise a different width as the second bottom width 60a, 60b, 60c, 60d. The first surface shape may comprise a same shape as the second surface shape. The first surface shape may comprise a different shape as the second surface shape. The first surface length 35a, 35b, 35c, 35d may comprise a same length as the second surface length 65a, 65b, 65c, 65d. The first surface length 35a, 35b, 35c, 35d may comprise a different length as the second surface length 65a, 65b, 65c, 65d.

In another embodiment, the first surface 15a, 15b, 15c, 15d is in a surface orientation angle 220a, 220b, 220c, 220d relative to the second surface 50a, 50b, 50c, 50d. The surface orientation angle 220a, 220b, 220c, 220d comprises an obtuse angle. The surface orientation angle 220a, 220b, 220c, 220d comprises an angle of 90 degrees or greater; the surface orientation angle 220a, 220b, 220c, 220d comprises an angle of 100 degrees or greater; the surface orientation angle 220a, 220b, 220c, 220d comprises an angle of 105 degrees or greater; the surface orientation angle 220a, 220b, 220c, 220d comprises an angle of 90 degrees to 170 degrees; the surface orientation angle 220a, 220b, 220c, 220d comprises an angle of 90 degrees to 150 degrees; the surface orientation angle 220a, 220b, 220c, 220d comprises an angle of 90 degrees to 130 degrees; and/or the surface orientation angle 220a, 220b, 220c, 220d comprises an angle of 90 degrees 110 degrees. The first surface 15a, 15b, 15c, 15d is non-parallel to the second surface 50a, 50b, 50c, 50d.

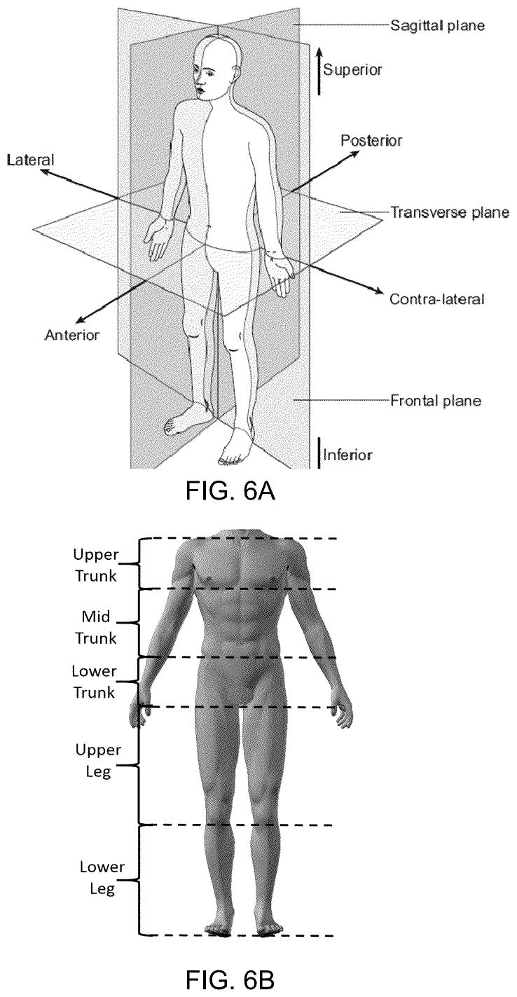

In another embodiment, the first surface 15a, 15b, 15c, 15d is intended or configured to contact, engage or support the anterior facing portions and/or the ventral region of a person's upper torso and head. The upper torso comprises a middle trunk and an upper trunk as shown in FIGS. 6A-6B. Accordingly, the second surface 50a, 50b, 50c, 50d is intended or configured to contact, engage or support the posterior facing portions and/or the dorsal region of a person's buttocks of the lower trunk. A person's ventral region should be facing at least a portion of the first surface 15a, 15b, 15c, 15d to straddle the sleeper 5, 135, 155, 165. The person should position their buttocks onto the second surface 50a, 50b, 50c, 50d and position the ventral region of their upper torso onto the first surface 50a, 50b, 50c, 50d. The person's upper legs should straddle the intersection region 20a, 20b, 20c, 20d comfortably without straining the upper legs or inner thighs, and the intersection region height 215a, 215b, 215c, 215d should enable the knees of the upper legs to be positioned at 90 degrees or substantially 90 degrees while a portion of the person's feet touch the ground. Alternatively, the intersection region height 215a, 215b, 215c, 215d should enable the knees of the upper legs to be positioned at 80 degrees or less while a portion of the person's feet touch the ground. The 80 degrees or less creates the open body angle by lowering the angle of the lower body, keeping the spine in alignment and the person properly positioned to sleep. The benefit of this position is that if one leans inward, the body angle remains 90° or wider.

Also, referring to FIGS. 1A-1C, 2A-2B, 3A-3D, 4A-4H, and 5D-5F, the sleeper 5, 135, 155, 165 comprises an intersection region 20a, 20b, 20c, 20d. The intersection region 20a, 20b, 20c 20d comprises an intersection width and an intersection height 215a, 215b, 215c, 215c. The intersection width may comprise the same or substantially the same as the first bottom width 45a, 45b, 45c, 45d or the second bottom width 60a, 60b, 60c, 60d. The intersection width may comprise the same or substantially the same as the first bottom width 45a, 45b, 45c, 45d and the second bottom width 60a, 60b, 60c, 60d. The intersection height 215a, 215b, 215c, 215c may comprise a height of 3 inches to 10 inches; may comprise a height of 5 inches to 8 inches; may comprise a height of at least 3 inches or greater; may comprise a height of at least 5 inches or greater; and/or may comprise a height of at least 7 inches or greater.

Alternatively, the intersection width may match or substantially match a person's sit bone width. The person may include an adult male, an adult female, a female child and/or a male child. The sit bone width is defined as the ischial tuberosity spacing among men, women and children. The intersection width should be wide enough to allow the person to straddle the sleeper 5, 135, 155, 165 without straining the inner thighs and comfortable enough to match or substantially match a person's sit bone width. The intersection height 215a, 215b, 215c, 215c should sufficiently allow the person to bend their legs in a 90-degree position or a substantially 90 degree position enabling at least a portion of the person's feet to touch the ground. Furthermore, at least a portion of the person's feet should be capable of reaching the ground to provide stability while sleeping and preventing them from falling off the sleeper 5, 135, 155, 165.

Also, referring to FIGS. 1A-1C, 2A-2B, 3A-3D, 4A-4H, and 5D-5F, the sleeper 5, 135, 155, 165 may comprise a base 10a, 10b, 10c, 10d. The base 10a, 10b, 10c, 10d supports the first surface 15a, 15b, 15c, 15d and the second surface 50a, 50b, 50c, 50d. The base 10a, 10b, 10c, 10d further comprises a flange 140 and/or one or more handle openings 110a, 110b, 110c, 110d. The flange 140 may be disposed at or adjacent to the bottom of the base 10a, 10b, 10c, 10d and/or surrounds the perimeter of the base 10a, 10b, 10c, 10d. The one or more handle openings 110a, 110b, 110c, 110d may be disposed onto the front, back, right or left sides of the base 10a, 10b, 10c, 10d. The one or more handle openings 110a, 110b, 110c, 110d may be sized and configured to receive a portion of a person's hand to enable the sleeper 5, 135, 155, 165 to be portable and moved easily.

In one embodiment, the sleeper 5, 135, 155, 165 and/or the base 10a, 10b, 10c, 10d may comprise a single-piece unit. The base 10a, 10b, 10c, 10d may comprise a first portion 210 and a second portion 215. The first portion 210 of the base 10a, 10b, 10c, 10d may comprise a first portion width, and a second portion 215 of the base 10a, 10b, 10c, 10d may comprise a second portion width. The first portion 210 of the base 10a, 10b, 10c, 10d supports the first surface 15a, 15b, 15c, 15d, and the second portion 215 of the base 10a, 10b, 10c, 10d supports the second surface 50a, 50b, 50c, 50d. The first portion width of the base 10a, 10b, 10c, 10d may be equal to or greater than the first top width 40a, 40b, 40c, 40d of the first surface 15a, 15b, 15c, 15d and/or the first bottom width 45a, 45b, 45c, 45d of the first surface 15a, 15b, 15c, 15d. The second portion width of the base 10a, 10b, 10c, 10d may be greater than or equal to the second top width 55a, 55b, 55c, 55d and/or the second bottom width 60a, 60b, 60c, 60d. Alternatively, the base 10a, 10b, 10c, 10d may taper outwardly from the first surface 15a, 15b, 15c, 15d and the second surface 50a, 50b, 50c, 50d towards the floor or ground to create a wider perimeter at the ground or floor for stability. The single-piece unit may be manufactured using a standard molding process known in the art.

In another embodiment, the sleeper 5, 135, 155, 165 and/or the base 10a, 10b, 10c, 10d may comprise a multi-piece unit. The multi-piece unit relates to a lightweight, compact folding sleeper 5, 135, 155, 165 which is capable of being easily folded from its open sleeping position to a flat planar position. The multi-piece unit is movable from a first position, a flat planar and/or substantially flat planar folded position, to a second position, an open sleeping position. The open sleeping position may comprise adjustable or movable first surface 15a, 15b, 15c, 15d relative to the second surface 50a, 50b, 50c, 50d, and/or adjustable or movable first and second portions of the base 10a, 10b, 10c, 10d.

The base 10a, 10b, 10c, 10d may comprise a first portion 210 and a second portion 215. The first portion 210 of the base 10a, 10b, 10c, 10d may comprise a first portion width, and a second portion 215 of the base 10a, 10b, 10c, 10d may comprise a second portion width. The first portion 210 of the base 10a, 10b, 10c, 10d supports the first surface 15a, 15b, 15c, 15d, and the second portion 215 of the base 10a, 10b, 10c, 10d supports the second surface 50a, 50b, 50c, 50d. The first portion width of the base 10a, 10b, 10c, 10d may be equal to or greater than the first top width 40a, 40b, 40c, 40d of the first surface 15a, 15b, 15c, 15d and/or the first bottom width 45a, 45b, 45c, 45d of the first surface 15a, 15b, 15c, 15d. The second portion width of the base 10a, 10b, 10c, 10d may be greater than or equal to the second top width 55a, 55b, 55c, 55d and/or the second bottom width 60a, 60b, 60c, 60d.

The first portion of the base 10a, 10b, 10c, 10d is movable relative to the second portion of the base 10a, 10b, 10c, 10d at one or more base orientation angles 225. The one or more base orientation angles 225 may be locked into position by a locking mechanism or latch mechanism 180. In one embodiment, the one or more base orientation angles 225 comprises an obtuse angle. The one or more base orientation angle 225 comprises an angle of 90 degrees or greater; the one or more base orientation angles 225 comprises an angle of 100 degrees or greater; the one or more base orientation angles 225 comprises an angle of 105 degrees or greater; the one or more base orientation angles 225 comprises an angle of 90 degrees to 170 degrees; the one or more base orientation angles 225 comprises an angle of 90 degrees to 150 degrees; the one or more base orientation angles 225 comprises an angle of 90 degrees to 130 degrees; and/or the one or more base orientation angles 225 comprises an angle of 90 degrees 110 degrees. The first portion of the base 10a, 10b, 10c, 10d is non-parallel to the second portion of the base 10a, 10b, 10c, 10d. In another embodiment, the one or more base orientation angles 225 comprises 180 degrees or substantially 180 degrees when the base 10a, 10b, 10c, 10d and/or sleeper 5, 135, 155, 165 is in its folded, flat planar configuration. Alternatively, the one or more base orientation angle 225 comprises 90 degrees to 110 degrees of adjustability when the base 10a, 10b, 10c, 10d and/or the sleeper 5, 135, 155, 165 is in its one or more open, unfolded configurations. The one or more base orientation angles 225 may comprise a same or different angle than the one or more surface orientation angles 220a, 220b, 220c, 220d. The one or more base orientation angles 225 may match or substantially match the one or more surface orientation angles 220a, 220b, 220c, 220d while in the unfolded one or more positions or configurations.

In one embodiment, the locking or latch mechanism 180 may comprise a rail 185, 190 and a rod or stand 195. The locking or latch mechanism 180 may further comprise a pin (not shown). The rail 185, 190 may be disposed on the first surface 15a, 15b, 15c, 15d second surface 50a, 50b, 50c, 50d, the base 10a, 10b, 10c, 10d, a first portion of the base 10a, 10b, 10c, 10d and/or a second portion of the base 10a, 10b, 10c, 10d. The rail 185, 190 may be disposed along the length and/or the vertical axis of the first surface 15a, 15b, 15c, 15d second surface 50a, 50b, 50c, 50d, the base 10a, 10b, 10c, 10d, a first portion of the base 10a, 10b, 10c, 10d and/or a second portion of the base 10a, 10b, 10c, 10d.

The rail 185, 190 comprises a first elongated member 185 and a second elongated member 190 that are spaced apart to create a channel, and the first elongated member 185 and second elongated member 190 are parallel to each other. The rod or stand 195 is disposed between the first elongated member 185 and the second elongated member 190 within the channel. The rod or stand 195 may comprise one or more notches, holes or hooks disposed along the length that are spaced apart to provide different base orientation angles 225 and/or surface angled orientations. The rod or stand 195 may be pivotally connected to at least a portion of the rail 185, 190. The rail 185, 190 is movable from a first position, a folded, unlocked position that is parallel to the rail 185, 190, to a second position, an unfolded, locked position. At least a portion of the rod or stand 195 may be inserted into a recess or opening 230. The recess or opening 230 may be sized and configured to receive at least portion of the rod or stand 195. The pin (not shown) may extend through the one or more notches, holes or hooks transversely to prevent the rod or stand 195 from sliding or moving further, thus locking the rod or stand 195 at the selected one or more base orientation angles 225. Alternatively, the pin (not shown) may engage with the one or more notches, holes or hooks to prevent the rod or stand 195 from sliding, thus locking the rod or stand 195 at the selected on or more base orientation angles 225.

Also, referring to FIGS. 1A-1C, 2A-2B, 3A-3D, 4A-4H, and 5D-5F, the sleeper 5, 135, 155, 165 may comprise a weight. The sleeper 5, 135, 155, 165 should be lightweight to increase portability. The weight of the sleeper 5, 135, 155, 165 comprises at least 1 lb or greater. The weight may further comprise 1 lb to 10 lb. Alternatively, the sleeper 5, 135, 155, 165 may comprise 10 lb or less. In another embodiment, the sleeper 5, 135, 155, 165 may include wheels or other portability mechanisms. In another embodiment, the sleeper 5, 135, 155, 165 may comprise one or more colors and/or a combination of colors.

Also, referring to FIGS. 1A-1C, 2A-2B, 3A-3D, 4A-4H, and 5D-5F, the sleeper 5, 135, 155, 165 comprises a material. The material may be a plastic, foam, or metal. The plastic may comprise a thermoset or thermoplastic. The plastic may comprise polypropylene (PP), polyethylene (PE), polyvinyl chloride (PVC), acrylonitrile butadiene styrene (ABS), polycarbonate (PC), and/or any combination thereof. The foam may comprise high-density polystyrene foam (HDPS), expanded polystyrene foam (EPS), polyurethane foam, craft foam, and/or any combination thereof. In another embodiment, the saddle sleeper may be solid or hollow. The material may further comprise a biodegradable material, an environmentally friendly or eco-friendly material.

Also, referring to FIGS. 1A-1C, 2A-2B, 3A-3D, 4A-4H, and 5D-5F, the sleeper 5, 135, 155, 165 may comprise one or more pads 125, 130. The one or more pads 125, 130 should increase comfort of the sleeper 5, 135, 155, 165. The one or more pads 125, 130 may be fixed or removably connected. The one or more pads 125, 130 may be disposed onto the first surface 15a, 15b, 15c, 15d or the second surface 50a, 50b, 50c, 50d. The one or more pads 125, 130 may be disposed onto each of the first surface 15a, 15b, 15c, 15d and the second surface 50a, 50b, 50c, 50d. The one or more pads 125, 130 may comprise components around the household, such as pillows, towels, or sheets that can increase the comfort of the sleeping child. The one or more pads 125, 130 may comprise attachment mechanisms, the attachment mechanisms include Velcro, adhesive, adhesive strips, and/or any mechanisms known in the art. The one or more pads 125, 130 may comprise removable coverings. The removable coverings may be separately washed and disposed onto the one or more pads 125, 130.

Also, referring to FIGS. 1A-1C, 2A-2B, 3A-3D, 4A-4H, and 5D-5F, the sleeper 5, 135, 155, 165 may comprise one or more guards or stops (not shown). The stop may be used to help prevent falling of the sleeping person. The stop may comprise a wall and/or a bar, and/or other mechanism to help prevent falls. The one or more rails or stops may be disposed onto the first surface 15a, 15b, 15c, 15d or the second surface 50a, 50b, 50c, 50d. The one or more guards or stops may be disposed onto each of the first surface 15a, 15b, 15c, 15d and the second surface 50a, 50b, 50c, 50d. The one or more guards extend along at least a portion of a first length 35a, 35b, 35c, 35d of the first surface 15a, 15b, 15c, 15d and/or at least a portion of a second length 65a, 65b, 65c, 65d of the second surface 50a, 50b, 50c, 50d. In one embodiment, a first one or more guards are disposed on right side of the first surface 15a, 15b, 15c, 15d and a second one or more guards are disposed on the left side of the first surface 15a, 15b, 15c, 15d. Alternatively, the one or more guards or stops may be disposed onto the right side, left side, top end and/or bottom end of the first surface 15a, 15b, 15c, 15d and/or the second surface 50a, 50b, 50c, 50d.

The foregoing descriptions of specific embodiments of the saddle sleeper have been presented for purposes of illustration and description. They are not intended to be exhaustive or to limit the saddle sleeper to the precise forms disclosed, and obviously many modifications and variations are possible in light of the above teaching. The exemplary embodiment was chosen and described in order to best explain the principles of the saddle sleeper and its practical application, to thereby enable others skilled in the art to best utilize the saddle sleeper and various embodiments with various modifications as are suited to the particular use contemplated.

I/We claim:

1. A sleeper comprising:
a first surface, the first surface comprises a first top width, a first bottom width, a first surface shape and a first surface angle, the first bottom width is smaller than the first top width;
a second surface, the second surface comprises a second top width, a second bottom width, a second surface shape and a second surface angle, the second bottom width is smaller than the second top width;
the first surface and the second surface intersect at an intersection region at a surface orientation angle, the intersection region includes an intersection height and an intersection width; and
a base, the base supporting the first surface and the second surface.

2. The sleeper of claim 1, wherein the sleeper is a one-piece unit.

3. The sleeper of claim 1, wherein the first surface angle comprises a different angle than the second surface angle.

4. The sleeper of claim 1, wherein the sleeper further comprises a plurality of pads, each of the plurality pads are disposed over the first surface and the second surface.

5. The sleeper of claim 1, wherein the first surface shape or the second surface shape comprises a planar, flat surface shape.

6. The sleeper of claim 1, wherein the first surface shape or the second surface shape comprises a concave surface shape.

7. The sleeper of claim 1, wherein the first surface is configured to support at least a portion of a ventral side of an upper torso of a person and the second surface is configured to support at least a portion of a dorsal side of a buttocks of a person.

8. The sleeper of claim 1, wherein the base comprises a first portion width and a second portion width, the first portion width is greater than the first top width and first bottom width, and the second portion width is greater than the second top width and second bottom width.

9. The sleeper of claim 1, wherein the sleeper is an adjustable, multi-piece unit.

10. The sleeper of claim 9, wherein the first surface is pivotally connected to the second surface to allow the first surface to move relative to the second surface.

11. The sleeper of claim 9, wherein the base comprises a base length, a first portion and a second portion, the first portion moves relative to the second portion to one or more base orientation angles of the base and the base length.

12. The sleeper of claim 11, the one or more base orientation angles may match or substantially match the one or more surface orientation angles.

13. A sleeper comprising:
a first surface, the first surface comprises a first surface width, a first surface shape and a first surface angle, the first surface is configured to support at least a portion of a ventral side of an upper torso of a person;
a second surface, the second surface comprises a second surface width, a second surface shape and a second surface angle, the second surface is configured to support least a portion of a buttocks of a person;
the first surface and the second surface intersect at a surface orientation angle at an intersection region, the intersection region includes an intersection width, intersection height, the intersection width comprises a smaller width than the first surface width and a second surface width; and
a base, the base supporting the first resting surface and the second resting surface.

14. The sleeper of claim 13, wherein the sleeper is a one-piece unit or an adjustable, multi-piece unit.

15. The sleeper of claim 14, wherein the adjustable, multi-piece unit comprises the base having a first portion and a second portion, the first portion moves relative to the second portion of the base.

16. The sleeper of claim 13, wherein the sleeper further comprises a plurality of pads, each of the plurality pads are disposed over the first surface and the second surface.

17. The sleeper of claim 13, wherein the first surface shape or the second surface shape comprises a planar, flat surface shape.

18. The sleeper of claim 13, wherein the first surface shape or the second surface shape comprises a concave surface shape.

19. The sleeper of claim 13, wherein the base comprises a first portion width and a second portion width, the first portion width is greater than the first top width and first bottom width, and the second portion width is greater than the second top width and second bottom width.

20. The sleeper of claim 1, wherein the surface orientation angle comprises an angle of 90 degrees to 110 degrees.
